(19) United States
(12) Patent Application Publication
(10) Pub. No.: US 2008/0168435 A1
(43) Pub. Date: Jul. 10, 2008

(54) Baseband firmware updating

(76) Inventors: David Tupman, San Francisco, CA (US); Jeff Bush, San Jose, CA (US); Steve Schell, San Mateo, CA (US)

Correspondence Address: ROPES & GRAY LLP, PATENT DOCKETING 39/361, 1211 AVENUE OF THE AMERICAS, NEW YORK, NY, 10036-8704, US

(21) Appl. No.: 11/649,999

(22) Filed: Jan. 5, 2007

(51) Int. Cl. G06F 9/44

(52) U.S. Cl. 717/173

(57) ABSTRACT

Systems and methods for protecting portable electronic devices against unauthorized or failed firmware update processes are provided, in particular for updating baseband firmware. In one embodiment, the firmware update process may require end-to-end signing, which may require a user to “sign” for a firmware update when receiving if from a source and then sign for it again when updating firmware with the firmware update, thereby providing an extra layer of security. In another embodiment, the media device processor may serve as a buffer between the a firmware update source and a firmware memory such as baseband firmware memory.

### BACKGROUND OF THE INVENTION

This relates to electronic devices and more particularly to systems and methods for updating firmware.

Firmware refers to software that controls the operation of a portable electronic device, including for example, applications implemented on the device, device specific functions (e.g., telephony and media player functions), the device interface, and the underlying operating system. Firmware is stored in the device and may be updated by “flashing” or replacing the stored firmware with a firmware update. Firmware updates may be used, for example, to fix “bugs” in the software or add additional functionality to the device.

Flashing or replacing firmware is a process which, if not properly executed or authorized, may be detrimental to the operation of the media device. For example, if a firmware update fails during a flash event, the device (or a portion thereof) may be rendered inoperable.

Accordingly, there is a need to protect electronic devices from unauthorized or failed firmware update processes.

### SUMMARY OF THE DISCLOSURE

Systems and methods for protecting portable electronic devices against unauthorized or failed firmware update processes are provided.

Firmware update processes may be implemented in a device by including an application portion and a carrier portion. The carrier portion can include circuitry for performing telephone functions (e.g., transmitting data to and receiving data from a communications tower). The carrier circuitry can include circuitry for other wireless communication functions, such as to enable Bluetooth and Wi-Fi communication methods. The application portion may include all other circuitry not specifically reserved for the carrier circuitry. For example, the application portion may include a processor, memory (e.g., for storing media files), SDRAM, a display, and other circuitry.

Devices may store firmware for one or more different subsystems or circuitry. For example, firmware may be provided for the carrier portion. Other firmware may be provided for the application portion. For example, processor firmware may be provided for controlling processor operations, the device operating system, the user interface, and other device functions.

Firmware updates may be made available to upgrade the firmware residing in firmware memory included in the device. A firmware update refers to the software that may be used to update, replace, or flash firmware existing in a firmware memory. Firmware memory refers to a storage device or circuitry that may be updated or flashed with a firmware update. Typically, firmware memory has firmware residing therein which may be updated with a firmware update. A firmware update process refers to a process of updating the firmware residing in a firmware memory.

The firmware update process may require a number of factors to be satisfied prior to and during a firmware update process. For example, firmware updating processes may require firmware specific authentication (e.g., digital signing) prior to updating baseband firmware. Firmware specific authentication provides an additional layer of security beyond any security measure or measures that may be taken in order for the media device to receive the firmware update in a first instance (e.g., downloaded from a host computer). As another example, firmware updating processes according to the invention may also require that the firmware memory receiving a firmware update be put in a firmware receive mode prior to undergoing a firmware update process. The firmware updating process may also monitor that status of a firmware update link (a communications pathway for routing the firmware update from a source to the firmware memory) to, for example, ensure that the firmware update can be transmitted uninterrupted.

The firmware updating process may utilize the media device processor to verify whether firmware may be updated. The processor may be used as a buffer to isolate the carrier circuitry portion (e.g., baseband circuitry) from a firmware update source. The isolation may be a communications isolation in that the firmware update source may not be permitted to update firmware stored in firmware memory (e.g., baseband memory) without prior authorization (e.g., procurement of firmware device specific signatures). The device processor may first have to authorize each firmware update before the update process can commence. This may be referred to as target authorization. In addition, communicative isolation may also prohibit direct communications between the firmware update source and the firmware memory (e.g., baseband memory), as the processor may require that firmware updates be routed through the processor before being transmitted to firmware memory.

Storing the firmware update, whether on a computer or the personal media device, may provide a failsafe against faulty firmware updating. For example, if during a firmware update process, a disturbance occurs that results in a faulty update in firmware, the firmware update process may be restarted because the firmware update is permanently stored and may be accessed later.

### BRIEF DESCRIPTION OF THE DRAWINGS

The above and other features of the present invention, its nature and various advantages will become more apparent upon consideration of the following detailed description, taken in conjunction with the accompanying drawings, in which like reference characters refer to like parts throughout, and in which:

FIG. 1 is a block diagram of a wireless network system for enabling a personal media device to wirelessly communicate directly or indirectly with a computer in accordance with an embodiment of the present invention;

FIG. 2 shows a block diagram of relatively long-range wireless communication system in accordance with an embodiment of the present invention;

FIG. 3 shows a simplified block diagram of portable media player in accordance with an embodiment of the present invention;

FIG. 4 is a flowchart showing steps that may be taken to update firmware stored in a personal media device in accordance with an embodiment of the present invention;

FIGS. 5A-E are illustrative screen shots that may be displayed during a firmware update process in accordance with an embodiment of the present invention;

FIGS. 6A-C are flowcharts showing steps that may be taken to perform one of the steps of FIG. 4 in accordance with an embodiment of the present invention;

FIG. 7 shows an illustrative diagram of a software package that may be provided in accordance with an embodiment of the present invention;

FIG. 8 is a flowchart for updating baseband firmware in accordance with an embodiment of the present invention;

FIG. 9 is a flowchart illustrating steps for re-starting the update of firmware stored in firmware memory in accordance with an embodiment of the present invention;

FIG. 10 is a flowchart showing steps that may be taken to update baseband firmware in accordance with an embodiment of the present invention; and

FIG. 11 is a flowchart showing steps that may be taken to update firmware of one or more firmware memories of a personal media device in accordance with an embodiment of the present invention.

### DETAILED DESCRIPTION OF THE DISCLOSURE

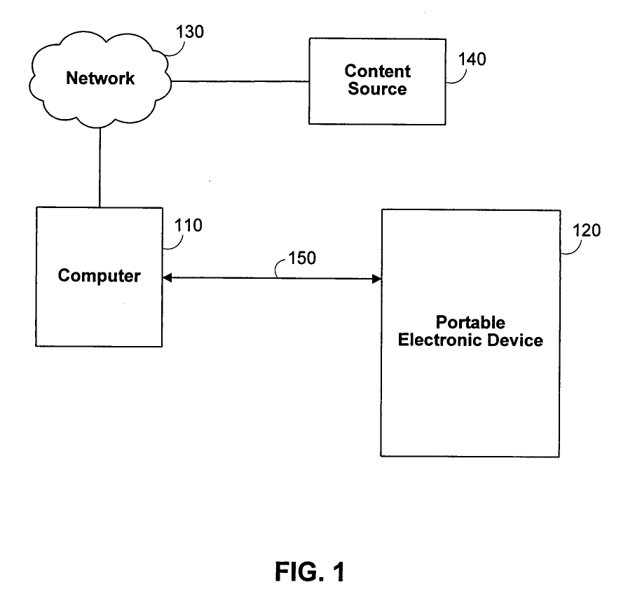

FIG. 1 is a block diagram of a system 100 for providing firmware updates to a portable electronic device. As shown, FIG. 1 includes a computer 110, a portable electronic device 120, network 130, and content source 140. Computer 110 may be, for example, a personal computer, a desktop computer, a laptop computer, or a server. Computer 110 may include storage devices such as hard-drives and memory, user-interface tools (e.g., keyboard and mouse), and a display device (e.g., an LCD or CRT). Computer 110 may communicate with device 120 over communications path 150.

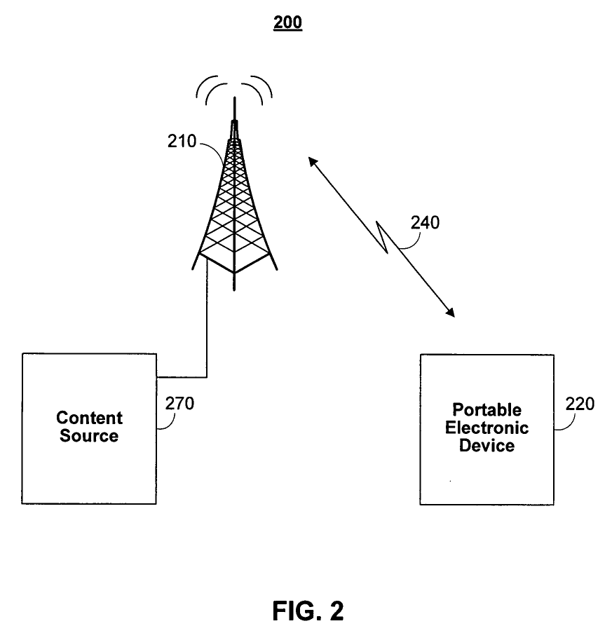

Communications path 150 may be a wired path in which computer 110 and device 120 can be electrically coupled together with a physical link (e.g., a cable such as a USB or Firewire cable). Alternatively, communications path 150 may be a wireless path in which computer 110 and personal media device 120 can be electrically coupled together using a wireless communication protocol. The wireless communication protocol may include a relatively short-range wireless protocol, which may include protocols such as Wi-Fi (e.g., a 802.11 protocol), Bluetooth (registered trademark), high frequency systems (e.g., 900 MHz, 2.4 GHz, and 5.6 GHz communication systems), or other relatively localized wireless communication protocol. Use of localized wireless communication may provide a localized region where wireless communication among devices (e.g., computer 110 and device 120) located within that region is possible. Computer 110 may be equipped with wireless communication circuitry (not shown) to communicate “directly” with device 120 or “indirectly” with device 120 using, for example, a wireless router (not shown) as a communications relay. In another approach, computer 110 may include communications circuitry that uses a wireless router to communicate with personal media device 120. It is understood that device 120 may be capable of relatively long-range communications (e.g., telephone communications), as discussed below in connection with FIG. 2. It is further understood that computer 110 and device 120 may communicate with each other using both wired and wireless communications paths.

Computer 110 may be connected to a network 130 to communicate with a content source 140. Network 130 may be a public network such as the Internet, a local area network, a wide area network, a private network, telephone network, cable network, broadband network, Ethernet network, digital subscriber line (DSL) network, or any other network that enables computer 110 and/or device 120 to access data available stored remote to computer 110 and device 120. Only one content source is shown to avoid overcrowding the figure, however, it is understood that network 130 may access more than one content source.

Content source 140 may provide a wide variety of content and perform numerous desired processes. For example, a content source may store and distribute media (e.g., music, audio books, podcasts, other audio content, television programs, movies, and other video content, weather information, news, stocks, ticketing information, schedule information, or any other desired information), software (e.g., firmware updates and application software and updates thereof), and security data (e.g., to prevent unauthorized installation of software) that may be received, for example, by and optionally stored on computer 110, device 120, and a combination thereof.

Content from content source 140 may be provided to computer 110 first, then transmitted to device 120. In another approach, content provided by content source 140 may be provided, for example, to device 120 over a path including network 130 and a wireless router (not shown), bypassing computer 110.

Content source 140 may be application specific and include equipment and processing software required to execute the application. For example, content source 140 may include authorization processing software to determine whether computer 110, device 120, or combination thereof is authorized to receive content from content source 140. Authorization processing may also provide end-user licenses which require a user's signature (e.g., acceptance) before such software can be downloaded to a computer (e.g., computer 110) or device (e.g., device 120). For example, content source may require a user or device (e.g., computer 110) signature before allowing the device to receive content. In addition, content source 140 may include one or more databases for keeping track of which content has been downloaded, for example, to computer 110 and for storing a particular user's personal preferences, subscription information, digital signatures, payment authorization information, and other suitable information. For example, content source 140 may keep track of the firmware update versions that have been downloaded by a particular user, computer, or personal media device.

System 100 includes a device 120. Device 120 may be an electronic device capable of communicating with another device (e.g., computer or content source) using a wired or wireless communications path or both. Examples of device 120 may include, for example, a media player such as an ipod available by Apple Computer Inc., of Cupertino, Calif., pocket-sized personal computers such as an iPAQ Pocket PC available by Hewlett Packard Inc., of Palo Alto, Calif., personal digital assistants (PDAs), and any other device. Device 120 may also include devices having media playing and telephone functionality. For example, device 120 may be a mobile telephone. Device 120 having telephone functionality may be capable of long-range wireless communication, as well as relatively short-range wireless communication.

FIG. 2 shows an illustrative block diagram of relatively long-range wireless communication system 200. System 200 may include a long-range communications transmitter/receiver 210, a device 220, and content source 270. Transmitter/receiver 210 may communicate with device 220 using a long-range communications protocol over long-range path 240. Content source 270 may be connected to transmitter/receiver 210 so that content stored at content source 270 can be transmitted to device 220 over path 240. Content source 270 may be similar to content source 140 of FIG. 1. Relatively long-range wireless communication protocols may include those used by wireless and cellular phones and personal email devices (e.g., Blackberry (registered trademark)). Relatively long-range wireless communications protocols may also include satellite communication.

While the differences between long-range and short-range wireless communications may at times become blurred (e.g., it may be difficult to differentiate the communication range of long and short-range protocols), one differentiating factor may be the bandwidth or data transfer rate of the wireless communication protocol. Certain short-range protocols may transfer data at a higher rate than long-range protocols. For example, a short-range wireless protocol such as 802.11 may transfer data at 54 Mb/s. Another differentiating factor may be power consumption. Certain short-range protocols may require more power to operate than their long-range counterparts. For example, a Wi-Fi communications protocol may consume more power than a telephony communications protocol. Other short-range protocols such as Bluetooth may consume less power than a long-range protocol with a tradeoff that it may not transmit data at a rate higher than the long-range counterpart. Thus, a tradeoff may exist between long and short-range wireless communication protocols, each protocol providing its own advantages.

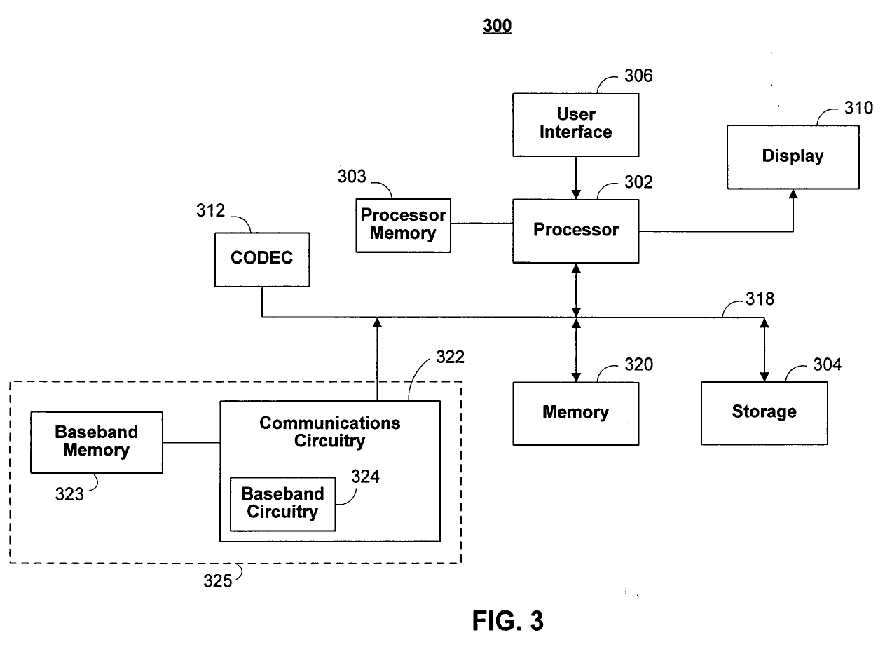

FIG. 3 shows a simplified block diagram of illustrative portable electronic device 300. Device 300 may include processor 302, processor memory 303, storage device 304, user interface 308, display 310, CODEC 312, bus 318, memory 320, communications circuitry 322, and baseband memory 323. Processor 302 can control the operation of many functions and other circuitry included in media player 300. Processor 302 may drive display 310 and may receive user inputs from user interface 308. Processor 302 may function as an “authorization/failsafe buffer” in accordance with the principles of the present invention when media device firmware is being updated.

Storage device 304 may store media (e.g., music and video files), software (e.g., for implanting functions on device 300, preference information (e.g., media playback preferences), lifestyle information (e.g., food preferences), exercise information (e.g., information obtained by exercise monitoring equipment), transaction information (e.g., information such as credit card information), wireless connection information (e.g., information that may enable media device to establish a wireless connection such as a telephone connection), subscription information (e.g., information that keeps tracks of podcasts or television shows or other media a user subscribes to), telephone information (e.g., telephone numbers), and any other suitable data. Storage device 304 may include one more storage mediums, including for example, a hard-drive, permanent memory such as ROM, semi-permanent memory such as RAM, or cache.

Memory 320 may include one or more different types of memory which may be used for performing device functions. For example, memory 320 may include cache, Flash, ROM, and/or RAM. Memory may be specifically dedicated to storing firmware. For example, processor memory 303 may store firmware for device applications (e.g., operating system, user interface functions, and processor functions). Processor memory 303 may be NAND flash. Baseband memory 323 may store firmware for baseband circuitry 324, which may be included as part of communications circuitry 323. Baseband memory 324 may be NOR flash. Baseband circuitry 324 may control telephony functions of media device 300.

Bus 318 may provide a data transfer path for transferring data to, from, or between storage device 304, communications circuitry 323, baseband circuitry 324, memory 320, and processor 302. Coder/decoder (CODEC) 112 may be included to convert digital audio signals into an analog signal, which may be provided to an output port (not shown).

Communications circuitry 322 and baseband memory 323 may be included in a carrier circuitry portion (delimited by dashed lines 325) of media device 300. Carrier circuitry portion 325 may be dedicated primarily to processing telephone functions and other wireless communications (e.g., Wi-Fi or Bluetooth). In addition, the operation of carrier circuitry portion 325, in particular baseband circuitry 324, may be controlled by carrier circuitry firmware (e.g., firmware stored in baseband memory 323). Using carrier circuitry firmware to control the operation of the carrier circuitry may, in effect, enable carrier circuitry to operate independent of other device components operating under the direction of other firmware. That is, carrier circuitry may be an independently operating subsystem within media device 300 that may communicate with other components within media device 300.

User interface 308 may allow a user to interact with the media player 300. For example, the user input device 308 can take a variety of forms, such as a button, keypad, dial, a click wheel, or a touch screen. Communications circuitry 322 may include circuitry for wireless communication (e.g., short-range and/or long range communication). For example, the wireless communication circuitry may be wi-fi enabling circuitry that permits wireless communication according to one of the 802.11 standards. Other wireless network protocols standards could also be used, either in alternative to the identified protocols or in addition to the identified protocol. Another network standard may be Bluetooth.

Communications circuitry 322 may also include circuitry that enables device 300 to be electrically coupled to another device (e.g., a computer or an accessory device) and communicate with that other device. As indicated above, communications circuitry 322 may also include baseband circuitry for performing relatively long-range communications (e.g., telephone communications). If desired, communications circuitry 322 may include circuitry for supporting both relatively long-range and short-range communications. For example, communications circuitry 322 may support telephone, Wi-Fi, and Bluetooth communications.

An application portion may exist in device 300 and may include all other circuitry not specifically reserved for carrier portion 325. For example, the application portion may include processor 212, storage circuitry 214 (e.g., for storing media files), SDRAM 216, a display 220, and other circuitry. The application portion may also include processor memory 303.

In one embodiment, device 300 may be a portable computing device dedicated to processing media, such as audio and video. For example, media player 300 may be a media player (e.g., MP3 player), a game player, a remote controller, a portable communication device, a remote ordering interface, an audio tour player, or other suitable personal device. In another embodiment, device 300 may be a portable device dedicated to providing media processing and telephone functionality in single integrated unit. Device 300 may be battery-operated and highly portable so as to allow a user to listen to music, play games or video, record video or take pictures, place and take telephone calls, communicate with others, control other devices, and any combination thereof. In addition, device 300 may be sized such that is fits relatively easily into a pocket or hand of the user. By being handheld, device 300 is relatively small and easily handled and utilized by its user and thus may be taken practically anywhere the user travels.

As indicated above, the carrier circuitry portion of a device according to the invention may operate according to firmware dedicated to carrier circuitry operation. In some embodiments, firmware may be specifically dedicated to baseband circuitry. Such firmware may be referred to herein as baseband firmware. At times, firmware updates may be made available to update the baseband firmware and other firmware that may be stored in the device.

Updating firmware can be a sensitive operation that may require a number of firmware update factors to be satisfied prior to and during a firmware update process. For example, firmware updating processes according to the invention may require firmware specific authentication (e.g., digital signing) prior to updating baseband firmware. Firmware specific authentication provides an additional layer of security beyond any security measure or measures that may be taken in order for the media device to receive the firmware update. As another example, firmware updating processes according to the invention may also require that the firmware memory receiving a firmware update be put in a firmware receive mode prior to undergoing a firmware update process. The firmware updating process may also monitor the status of a firmware update link (a communications pathway for routing the firmware update from a source to the firmware memory) to ensure that the firmware update can be transmitted uninterrupted, and if any interruption does occur, the update process may be restarted.

The firmware updating process may utilize the device processor (e.g., processor 302) to verify whether the firmware update factors are satisfied. The processor may be used as a buffer to isolate the carrier circuitry portion (e.g., baseband circuitry) from a firmware update source. The firmware update source may be a content source (e.g., content source 140 of FIG. 1), a computer (e.g., computer 110 of FIG. 1), or a storage device or memory located in the personal media device. The isolation may be a communications isolation in that the firmware update source may not be permitted to update firmware stored in firmware memory (e.g., baseband memory) without prior authorization (e.g., procurement of firmware device specific signatures). The device processor may first have to authorize each firmware update before the update process can commence. In addition, communicative isolation may also prohibit direct communications between the firmware update source and the firmware memory (e.g., baseband memory). The processor may require that firmware updates be routed through the processor before being transmitted to firmware memory.

Communicatively isolating the carrier circuitry from a firmware update source with the device processor advantageously guards against unauthorized attempts to update baseband firmware. For example, an unauthorized baseband firmware update may render the personal media device inoperable (or a least a portion of the carrier circuitry inoperable). Other unauthorized baseband firmware update processes may prevent a service (that provides the infrastructure to permit telephone communications) from recognizing a personal media device or granting access to its network. In yet another unauthorized firmware update process, the application portion may not be able to communicate with the carrier portion.

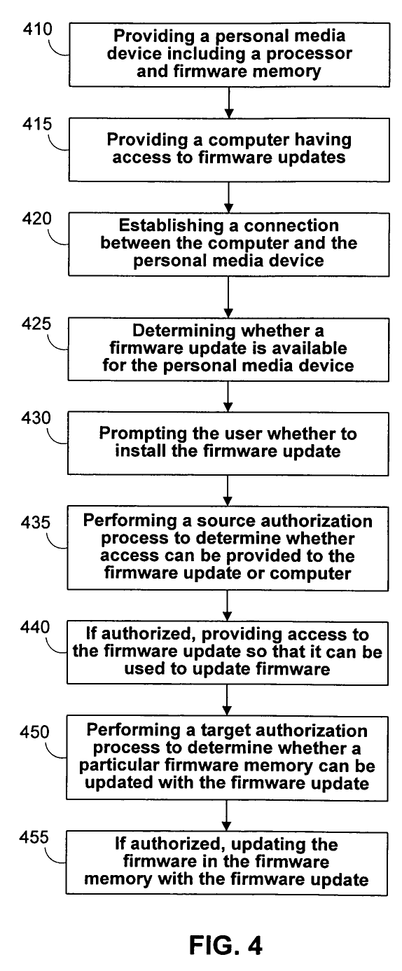

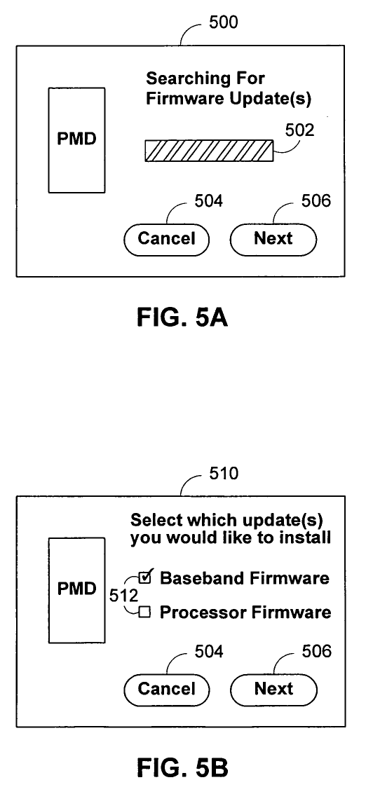

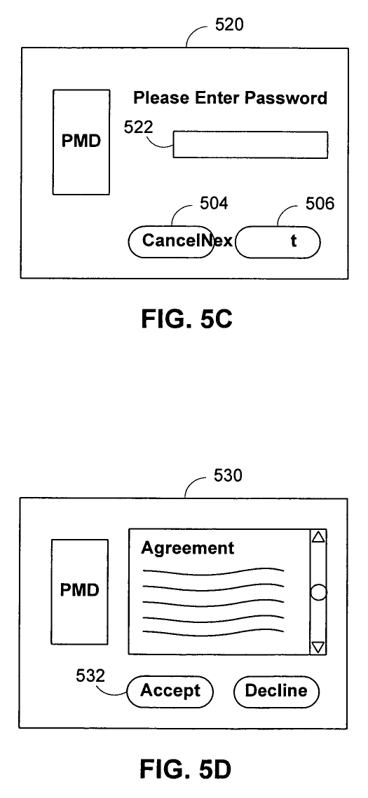

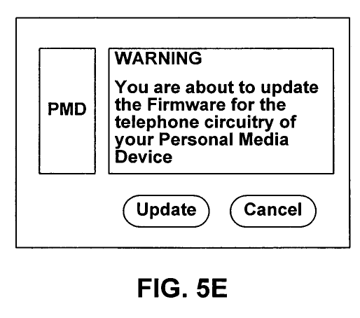

FIG. 4 is an illustrative flowchart showing various steps that may be taken to update firmware stored in a portable electronic device. FIG. 4 is discussed in connection with screen shots shown in FIGS. 5A-E. The screen shots in FIGS. 5A-E may be displayed on the computer, the personal media device, or both, and may include interactive elements which may be accessed using the computer, the media device, or both. At step 410, a personal media device (e.g., device 300 of FIG. 3) including a processor and firmware memory may be provided. At step 415, a computer having access to firmware updates may be provided. The computer may access firmware updates (e.g., baseband firmware updates and processor firmware updates) by communicating with a content source. The computer may also access other software and data located at the content source.

At step 420, a connection between the device and the computer may be established. This connection may be a wired connection in which a cable (e.g., USB cable) physically connects the computer to the device, or it may be a wireless connection. At step 425, a determination is made as to whether a firmware update is available for the device. For example, the computer (the application processor or a baseband processor) may check to see which version of baseband circuitry is currently installed on the media device and make a determination whether baseband firmware updates are available. While the determination is being made, a user may be presented with illustrative screen 500 as shown in FIG. 5A. Screen 500 may include a progress indicator 502 to graphically illustrate progress of a firmware update search and interactive “cancel” element 504, which may be selected to cancel out of the update process, and “next” element 506, which may be selected when the firmware update search is complete.

If a firmware update is available, a user may be prompted whether to install the firmware update, as shown in step 430. See, for example, screen 510 of FIG. 5B, which enables a user to select which update(s) to install. A user may select which updates to install by navigating a selection element (not shown) to one or more of boxes 512 and selecting one or more of boxes 512. After the user is finished selecting which updates to install, the user may select next element 506.

At step 435, a source authorization process may be performed to determine whether access can be provided to the firmware updates for installation. That is, the source authorization process may authorize the computer or the device to receive the firmware update, but not necessarily to update firmware stored in firmware memory with the firmware update. The source authorization process may be performed by the computer or one of the device processors (such as the application processor or baseband processor). Authorization to update firmware stored in a firmware memory may require a target authorization process (as discussed in more detail below in connection with step 450).

The source authorization process may require a user to enter, for example, a password in order for the computer or device to receive the firmware update. FIG. 5C shows an illustrative screen 520 prompting the user to enter a password in field 522. Alternatively, or in addition to, the password requirement, the source authorization process may require a user to accept the terms of an agreement (e.g., license agreement). An illustrative license agreement is shown in FIG. 5D in screen 530. A user may accept the agreement by selecting accept element 532.

A 'signing” process may be performed without user intervention. Signing may uses a digital signature to cryptographically verify that the firmware update file has not changed since its creation. A digital signature, as defined herein, refers to a cryptographically based signature. Digital signatures may use asymmetric key algorithms and can use public key infrastructure (PKI) schemes in which the public key used in the signature scheme is tied to a user by a digital identity certificate issued by a certificate authority. PKI systems attempt to unbreakably bind user information (e.g., firmware version number, name, or SIMM Card information) to a public key. There are several digital signature schemes use two complementary algorithms: one for signing and the other for checking the signature at some later time.

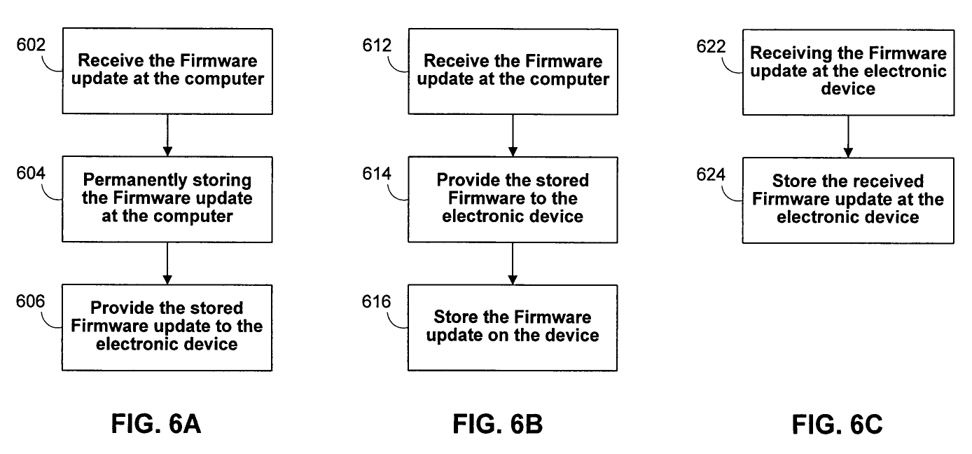

If the source authorization process results in authorization, the firmware update may be made available for updating the firmware stored in firmware memory. Access may be provided in a number of different ways. In one approach, as shown in FIG. 6A, the firmware update may be received at a computer (step 602) and permanently stored on the computer (at step 604). At step 606, the stored firmware may be provided to the device for use in updating firmware. In another approach, as shown in FIG. 6B, the firmware update may be received by a computer (at step 612). The computer may provide the received firmware update to the device (at step 614). At step 616, the device may store the firmware update. Storing in the context of step 616 is not meant to include storing the firmware update such that it updates the desired contents of a firmware memory, rather it is meant to store the firmware update in a medium from which the firmware update may be retrieved and transmitted to a desired firmware memory. In yet another approach, as shown in FIG. 6C, the firmware update may be received at the device (at step 622) and stored at the device (at step 624). Storing in the context of step 624 is meant to be interpreted in the same manner as that meant for step 616. The steps shown in FIG. 6C show an example in which the device may receive a firmware update from a content source, effectively eliminating use of a computer (e.g., a host computer) from which the personal media device directly retrieves firmware updates. This example may represent an embodiment where the personal media device receives firmware updates over-the-air from a content source.

Storing the firmware update, whether on a computer or the device, may provide a failsafe against faulty firmware updating. For example, if during a firmware update process, a disturbance occurs that results in faulty update in firmware, the firmware update process may be restarted because the firmware update is permanently stored and may be accessed later.

Referring back to FIG. 4, at step 450, a target authorization process may be performed to determine whether a particular firmware memory may be authorized to be updated with the firmware update. The target authorization process provides an extra layer of security in ensuring that the “target” firmware memory (baseband firmware memory) is in fact authorized to be updated with the firmware update (even though the firmware update may have been previously authorized in the source authorization process). The target authorization process may require a user to “sign” for the firmware update. For example, the user may “sign” another agreement or acknowledge that a firmware update is about to commence. FIG. 5E shows a screen shot providing the user with the ability to select an update element 542 to update the firmware.

At step 455, if the target authorization process results in authorization, the firmware in the firmware memory may be updated with the firmware update. For example, if authorization is provided to update the firmware in the baseband firmware memory, that firmware may be updated with a baseband firmware update.

End-to-end signing may be provided when updating firmware in accordance with the present invention. This provides security “checkpoints” at multiple points along a firmware update path, a path along which a firmware update may be routed to reach a particular firmware memory. A first security checkpoint may occur at the source, a point at which the personal media device may be granted access to a firmware update. For example, a source may be the point where a computer provides a firmware update to the personal media device. In another example, the source may be the point where the content source provides the firmware update to the computer or the personal media device. A second security checkpoint may occur at the target, a point at which a particular firmware memory is to be updated with a firmware update. For example, a target check point may occur when the processor addresses a firmware memory in preparation for updating the firmware in that firmware memory.

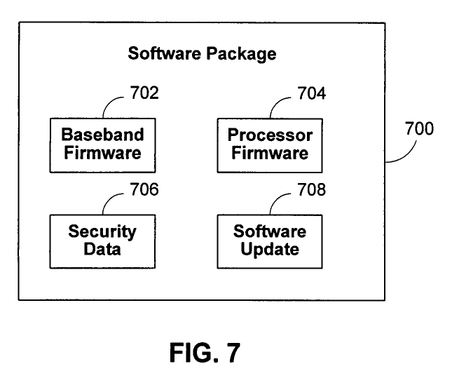

FIG. 7 shows an illustrative diagram of a software package 700 that may be received by a computer or the device in accordance with the principles of the present invention. Software package 700 may include an assortment of software, software updates, firmware updates, security data, and other data. As shown, software package 700 may include baseband firmware update 702, processor firmware update 704, security data 706 (e.g., encryption data that restricts access to the contents of package 700), and software update 708 (e.g., patches for applications that may be executed on the personal media device). In one embodiment, software package 700 may be signed for at a source point. Then, an element (e.g., baseband firmware update) of package 700 may be signed for at a target point. If desired, a collection of elements (e.g., all firmware updates) may be signed for jointly, instead of independently.

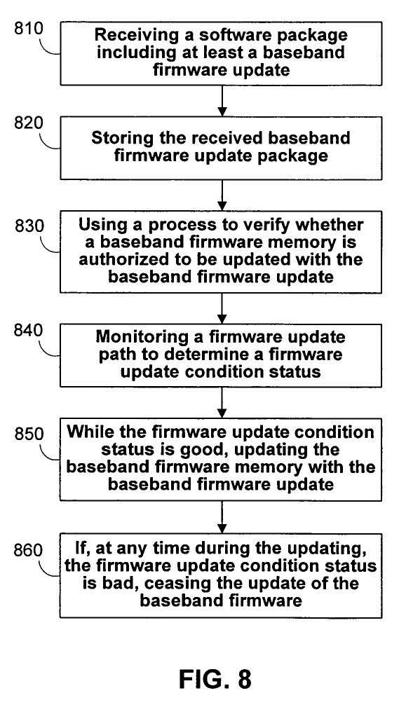

FIG. 8 is an illustrative flowchart for updating baseband firmware. At step 810, a software package is received. The software package includes at least a baseband firmware update. At step 820, the received software package may be stored, for example, in a hard-drive on the device. At step 830, the device processor may be used to verify whether baseband memory is authorized to be updated with the baseband firmware update. For example, the processor may establish a “hand-shake” with baseband circuitry to put the baseband circuitry in a condition (e.g., a firmware update receive mode) to receive the baseband firmware update and load the update into the baseband firmware memory.

At step 840, a firmware update path may be monitored to determine a firmware update path condition status. As indicated above, a firmware update path may include the path through which a firmware update is routed, from source to target. For example, the firmware update path for a baseband firmware update may include the storage device storing the baseband firmware update, the processor, the baseband circuitry, and the baseband firmware memory. The condition status may have two states: good and bad. A good status may indicate that update path is stable and the firmware update can be safely transmitted to the firmware memory. A bad status may indicate the occurrence of an event that disrupts the transfer of a firmware update. The disruption may be physical (e.g., a disconnected wire or personal media device dropped), electrical (e.g., loss of power, reset button pressed, or electromagnetic interference), or a software glitch. The processor may monitor the firmware update path condition status.

At step 850, while the firmware update path status is good, the baseband firmware memory may be updated with the baseband firmware update. This may be accomplished by routing the baseband firmware update through the processor to the baseband firmware memory via the baseband firmware update path. If, at anytime during the updating (of step 850), the firmware update path condition status is bad, the update of the baseband firmware stored in the baseband firmware memory may cease, as indicated at step 860.

It is understood that the steps shown in FIG. 8 are merely illustrative and that steps may be modified, that additional steps may be added, and that steps may be omitted. For example, similar steps may be practiced to update processor firmware. Note that in some embodiments, all of the steps of FIG. 8 may take place exclusively within a personal media device.

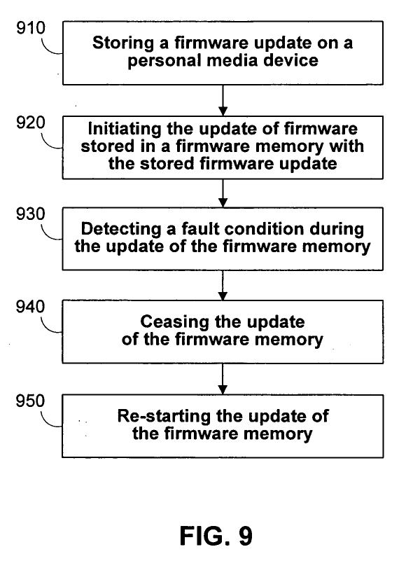

FIG. 9 is an illustrative flowchart illustrating various steps for re-starting the update of firmware stored in firmware memory. At step 910, a firmware update is stored on a device, for example, in a hard-drive or other memory not intended to be updated with the firmware update. At step 920, the update of firmware in a firmware memory (e.g., baseband firmware memory) with the stored firmware update is initiated. At step 930, a fault condition is detected during the update of the firmware memory. Such a fault condition may result in ceasing the update of the firmware memory, as indicated by step 940.

At step 950, the update of the firmware memory may be restarted. For example, when the processor detects that the firmware update was not properly loaded into the firmware memory or that the firmware fails a self-diagnostic check, the processor may re-direct the stored firmware update to the firmware memory. Thus, by storing the firmware update on the device in a storage medium (e.g., SDRAM) other than its intended storage medium (e.g., firmware memory), the device may be protected against faulty firmware update processes. It adds robustness to the device.

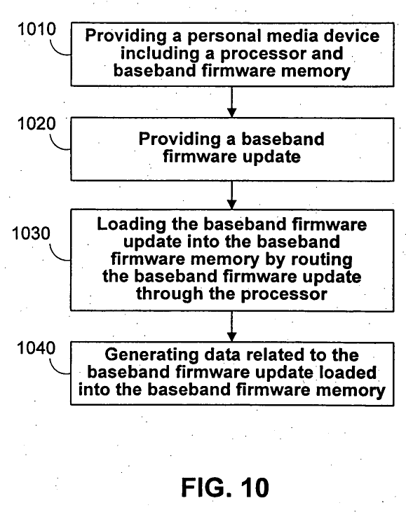

FIG. 10 is another illustrative flowchart showing various steps that may be taken to update baseband firmware. At step 1010, a device including a processor and a baseband firmware memory is provided. At step 1020, a baseband firmware update is provided. At step 1030, the based baseband firmware update is loaded into the baseband firmware memory by routing the baseband firmware update through the processor.

At step 1040, data related to the baseband firmware update loaded into the baseband firmware memory is generated. This data may reflect which baseband firmware update version is currently loaded into the baseband firmware memory. The data generated may be a number unique to only that personal media device. The number may be generated based on the baseband firmware update, the processor, or any other information or other component (e.g., SIMM card). The number may be stored in the baseband firmware memory. The number may be transmitted to a telephone network to allow the telephone network to identify, for example, the personal media device accessing the network and the baseband firmware update being used by the personal media device.

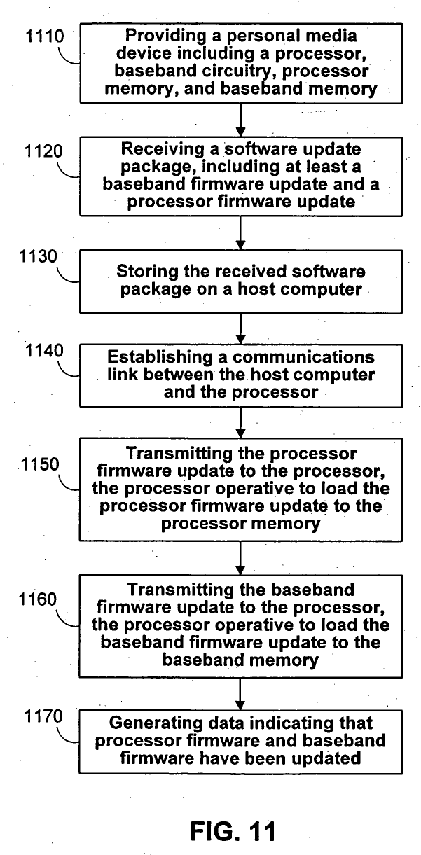

FIG. 11 is an illustrative flowchart showing various steps that may be taken to update firmware of one or more firmware memories of a device. This flowchart illustrates how a host computer may communicate with the processor of the device (e.g., mobile phone) when a firmware update process is performed. At step 1110, a device including an application processor, baseband circuitry, processor firmware memory, and baseband memory is provided. At step 1120, a software package including at least a baseband firmware update and a processor firmware update is received. The received software package may be stored on a host computer, as indicated at step 1130.

At step 1140, a communications link is established between the host computer and the processor of the device. In effect, by communicating with the processor and not, for example, the baseband circuitry, the processor may serve as a “buffer” between the host computer supplying a firmware update and the firmware memory targeted to receive that firmware update. At step 1150, the processor firmware update may be transmitted to the processor, which is operative to load the processor firmware update into the processor firmware memory. At step 1160, the baseband firmware update is transmitted to the processor, which is operative to load the baseband firmware update into the baseband firmware memory. The processor firmware update and the baseband firmware update may be retrieved directly from the host computer or a storage device resident on the personal media device.

At step 1170, data may be generated to indicate that the processor firmware memory and the baseband firmware memory have been updated.

Thus it is seen that systems and methods for updating firmware are provided. Those skilled in the art will appreciate that the invention can be practiced by other than the described embodiments, which are presented for purposes of illustration rather than of limitation, and the invention is limited only by the claims which follow.

What is claimed is:

1. A method for updating firmware of a portable electronic device comprising a processor and firmware memory, the method comprising:
updating firmware stored in the firmware memory by routing a firmware update through the processor to the firmware memory; and
using source and target authorization processes prior to performing the updating.

2. The method of claim 1, further comprising:
receiving the firmware update over a wired communications link.

3. The method of claim 1, further comprising:
receiving the firmware update over an over-the-air communications link.

4. The method of claim 1, further comprising:
verifying that the firmware update is authorized for use in updating the firmware in the firmware memory.

5. The method of claim 1, further comprising:
monitoring the status of a firmware update transfer link through which the firmware update is routed, the status comprising a fault status; and
in response to monitoring a fault status, ceasing to update the firmware.

6. The method of claim 1, further comprising:
detecting a firmware update failure; and
re-starting the updating.

7. The method of claim 1, further comprising:
generating data related to firmware update loaded into the firmware memory.

8. The method of claim 1, wherein the firmware update is a baseband firmware update and wherein the firmware memory is baseband firmware memory.

9. A portable electronic device, comprising:
baseband circuitry;
baseband firmware memory electrically coupled to the baseband circuitry;
a storage device; and
a processor operative to communicate with the baseband circuitry and the storage device, the processor further operative to:
store a baseband firmware update in the storage circuitry;
authorize a firmware update process with the baseband circuitry; and
update the baseband firmware stored in the baseband firmware memory with the baseband firmware update when the firmware update process is authorized.

10. The device of claim 9, wherein the processor is operative to:
transfer the baseband firmware update from the storage circuitry to the baseband circuitry when the firmware update process is authorized, the baseband circuitry operative to update baseband firmware with the baseband firmware update.

11. The device of claim 9, wherein the processor is operative to monitor a firmware update link for a disturbance.

12. The device of claim 11, wherein the processor is operative to cease updating the baseband firmware in the event of a monitored disturbance.

13. The device of claim 11, wherein the processor is operative to re-start updating the baseband firmware stored in the baseband firmware circuitry after an occurrence of a monitored disturbance.

14. The device of claim 9, wherein the baseband circuitry is operative to generate a unique version number based on the baseband firmware update stored in the baseband firmware memory.

15. The device of claim 14, wherein the baseband circuitry is operative to store the unique version number in the baseband firmware memory.

16. The device of claim 9, wherein the device is mobile telephone.

17. A method for updating software of a telephony media device comprising a processor, baseband circuitry, and baseband firmware memory, the method comprising:
receiving a software update package comprising a baseband firmware update;
using the processor to authorize the baseband circuitry to receive the baseband firmware update; and
when authorization is provided, updating the baseband firmware in the baseband firmware memory with the baseband firmware update.

18. The method of claim 17, further comprising:
authorizing an external client to provide the software package to the personal media device.

19. The method of claim 17, further comprising:
storing at least the baseband firmware update in storage circuitry other than the baseband firmware memory.

20. The method of claim 17, wherein updating comprises routing the baseband firmware update through a communications path comprising the processor, the baseband circuitry, and the baseband firmware memory.

21. The method of claim 20, further comprising restarting the updating in the event of a disturbance of the updating.

22. The method of claim 17, further comprising:
generating a unique version number based on the baseband firmware update and the processor; and
storing the unique version number in the baseband firmware memory.

23. The method of claim 17, further comprising transmitting the unique version number.

24. A method for providing a plurality of security checkpoints for a firmware update performed using a telephone media device, the method comprising:
determining whether a personal media device is authorized to receive software, the software comprising a firmware update;
receiving the software when the media device is authorized to receive the software; and
determining whether the personal media device is authorized to update firmware with the firmware update.

25. The method of claim 24, further comprising updating the firmware with the firmware update when the media device is authorized to update firmware.

26. The method of claim 24, further comprising providing a digital signature to authorize receipt of the software.

27. The method of claim 24, further comprising providing a digital signature to authorize updating of the firmware.

28. A system, comprising:
a host computer for providing a baseband firmware update;
a telephone device comprising a processor and baseband firmware memory; and
a communications link that electrically couples the host computer to the device,
the host computer operative to communicate with the processor to provide the baseband firmware update to the device.
